(19) United States
(12) Patent Application Publication
(10) Pub. No.: US 2025/0110261 A1
(43) Pub. Date: Apr. 3, 2025

(54) Optical Film and Optical Lens Including Same

(71) Applicant: 3M INNOVATIVE PROPERTIES COMPANY, St. Paul, MN (US)

(72) Inventors: Kevin T. Huseby, Oakdale, MN (US); Stephen A. Johnson, Woodbury, MN (US); Adam D. Haag, Woodbury, MN (US); John D. Le, San Jose, CA (US); Jacob D. Young, St. Paul, MN (US); Brian R. Peterson, Glenwood City, WI (US); Kayla A. McGrath, Cottage Grove, MN (US)

(21) Appl. No.: 18/725,256

(22) PCT Filed: Jan. 10, 2023
(86) PCT No.: PCT/IB2023/050206

§ 371 Date: Jun. 28, 2024

Related U.S. Application Data
(60) Provisional application No. 63/300,344, filed on Jan. 18, 2022.

(51) Int. Cl. G02B 1/111; B29C 48/00; B29C 48/18; B29C 48/21; B29C 48/22; B29K 23/00; B29K 105/00; B29L 11/00; G02B 3/00; G02B 5/08

(52) U.S. Cl. CPC G02B 1/111; B29C 48/0018; B29C 48/185; B29C 48/21; B29C 48/22; G02B 5/0841; B29K 2023/06; B29K 2023/38; B29K 2105/0085; B29K 2105/0094; B29K 2105/0097; B29K 2995/0026; B29K 2995/0072; B29K 2995/0098; B29L 2011/00; G02B 3/00

(57) ABSTRACT

An optical film includes a plurality of alternating first and second polymeric layers disposed on a first protective layer. Each of the first and second polymeric layers has an average thickness less than about 500 nm and the first protective layer has an average thickness greater than about 750 nm. An olefin layer can be disposed on the first protective layer opposite the plurality of alternating first and second polymeric layers. The olefin layer includes cyclic olefin copolymer, cyclic olefin polymer, or a blend thereof. The olefin layer can have an unstructured major surface opposite the first protective layer. A bonding layer is disposed between, and bonds together, the olefin layer and the first protective layer. The optical film is integrally formed.

### SUMMARY

In some aspects, the present description provides an optical film including a plurality of alternating first and second polymeric layers disposed on a first protective layer. Each of the first and second polymeric layers has an average thickness less than about 500 nm and the first protective layer has an average thickness greater than about 750 nm. An olefin layer can be disposed on the first protective layer opposite the plurality of alternating first and second polymeric layers. The olefin layer includes cyclic olefin copolymer, cyclic olefin polymer, or a blend thereof. The olefin layer can have an unstructured major surface opposite the first protective layer. A bonding layer is disposed between, and bonds together, the olefin layer and the first protective layer. The optical film is integrally formed.

In some aspects, the present description provides an optical film including a plurality of alternating first and second polymeric layers disposed on a first protective layer is provided. Each of the first and second polymeric layers has an average thickness less than about 500 nm and the first protective layer has an average thickness greater than about 750 nm. An olefin layer can be disposed on the first protective layer opposite the plurality of alternating first and second polymeric layers. The olefin layer can include cyclic olefin copolymer, cyclic olefin polymer, or a blend thereof. A bonding layer is disposed between, and bonds together, the olefin layer and the first protective layer. A composition of the bonding layer can be different from compositions of each of the first protective layer and the first and second polymeric layers. The optical film is integrally formed.

In some aspects, the present description provides an optical film including a plurality of alternating first and second polymeric layers disposed on a first protective layer. Each of the first and second polymeric layers has an average thickness less than about 500 nm and the first protective layer has an average thickness greater than about 750 nm. An ethylene copolymer layer can be disposed on the first protective layer opposite the plurality of alternating first and second polymeric layers. The optical film is integrally formed.

In some aspects, the present description provides a method of making an optical lens. The method includes providing an integrally formed optical film including a plurality of alternating first and second polymeric layers disposed on a first protective layer, where each of the first and second polymeric layers can have an average thickness less than about 500 nm and the first protective layer can have an average thickness greater than about 750 nm. An olefin layer is disposed on the first protective layer opposite the plurality of alternating first and second polymeric layers. The olefin layer comprises cyclic olefin copolymer, cyclic olefin polymer, or a blend thereof. A bonding layer is disposed between, and bonds together, the olefin layer and the first protective layer. The method includes molding a lens substrate onto the optical film such that the lens substrate faces and bonds to the olefin layer. The lens substrate comprises an olefin composition.

These and other aspects will be apparent from the following detailed description. In no event, however, should this brief summary be construed to limit the claimable subject matter.

### BRIEF DESCRIPTION OF THE DRAWINGS

FIGS. 1-2 are schematic cross-sectional views of optical films, according to some embodiments.

FIG. 3 is a schematic cross-sectional view of an optical lens, according to some embodiments.

FIG. 4 is a schematic illustration of a method of making an optical lens, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An optical system can include one or more optical lens that include an optical film disposed on a lens substrate. For example, an optical system as described in U.S. Pat. No. 9,557,568 (Ouderkirk et al), for example, includes an optical lens having a reflective polarizer film disposed on a lens substrate. In some embodiments, it is desired that the lens substrate be formed from an olefin such as cyclic olefin copolymer (COC) or cyclic olefin polymer (COP) due, at least in part, to the low birefringence of such materials. However, it can be difficult to achieve adequate bonding of such lens substrates with typical materials (e.g., polyesters) used in multilayer optical films. According to some embodiments, it has been found that an optical film can include an outer layer that bonds well to such lens substrates and an additional bonding layer that bonds the outer layer to another layer of the optical film. It has been found, according to some embodiments, that the materials for the outer layer, the bonding layer, and the other layers of the optical film can be chosen so that the film can be integrally formed via coextrusion and co-stretching, for example.

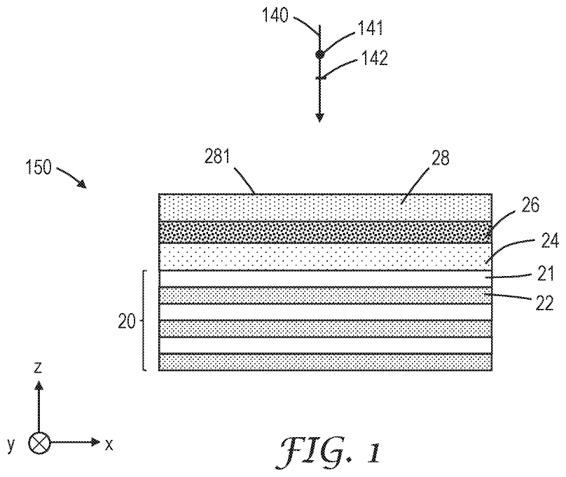

FIG. 1 is a schematic cross-sectional views of an optical film 150, according to some embodiments. FIG. 2 is a schematic cross-sectional views of an optical film 150′, according to some other embodiments. The optical film 150, 150′ includes a plurality 20 of alternating first (21) and second (22) polymeric layers disposed on a first protective layer 24. In some embodiments, the optical film 150, 150′ includes an olefin layer 28 disposed on the first protective layer 24 opposite the plurality 20 of alternating first and second polymeric layers and includes a bonding layer 26 disposed between, and bonding together, the olefin layer 28 and the first protective layer 24.

In some embodiments, each of the first and second polymeric layers has an average thickness of less than about 500, 400, 350, 300, 250, or 200 nm. The average thickness may be, for example, at least about 20 nm or at least about 40 nm. For example, in some embodiments, each of the first and second polymeric layers has an average thickness in a range of about 20 nm to about 500 nm or about 40 nm to about 400 nm. In some embodiments, the first protective layer 24 has an average thickness greater than about 750, 1000, 1500, or 2000 nm, for example. The average thickness can be up to about 30 micrometer or up to about 20 micrometers, for example. In some embodiments, each of the first and second polymeric layers has an average thickness of less than about 500 and the first protective layer has an average thickness greater than about 750 nm, for example. In some embodiments, the bonding layer 26 has an average thickness in a range of about 0.5 to 20 microns, or about 1 to 10 microns, or about 1.5 to 8 microns. In some embodiments, the bonding layer 26 has an average thickness greater than the average thickness of each of the first and second polymeric layers. In some embodiments, the bonding layer 26 has an average thickness greater than the average thickness of the first protective layer 24.

In some embodiments, the plurality of alternating first and second polymeric layers number at least 10, 20, 50, 75, 100, 150, 200, 250, 300, 350, or 400 in total. The plurality of alternating first and second polymeric layers may number, for example, up to 1500 or 1000 in total. For example, the plurality of alternating first and second polymeric layers 21, 22 may number from 10 to 1500 or from 20 to 1000 in total. in total.

The optical film 150, 150′ can include additional layers. For example, the optical film can include a second protective layer 24′ disposed on the plurality of alternating layers 21, 22 opposite the first protective layer 24. The optical film may further include one or more additional layers 25 disposed between sub-pluralities of the plurality of alternating layers 21, 22, as schematically illustrated in FIG. 2. The one or more additional layers 25 (and the layers 24, 24′) may be protective boundary layers as would be appreciated by those of ordinary skill in the art. Each of the one or more additional layers 25, and/or the second protective layer 24′, can have an average thickness in any range described for the first protective layer 24.

In some embodiments, the bonding layer 26 includes a plurality of sublayers. For example, the bonding layer 26 can include a sublayer 26a for bonding to the olefin layer 28 and a sublayer 26b for bonding to the first protective layer 24. The plurality of sublayers may include only 2 sublayers or may include more than 2 sublayers. In some embodiments, the bonding layer 26 is a single monolithic layer which may directly contact the olefin layer 28 and the first protective layer 24.

In some embodiments, the olefin layer 28 has an unstructured major surface 281 opposite the first protective layer 24. An unstructured major surface is generally free of structures (e.g., microstructures) generated in the surface for any optical or mechanical purpose, for example, but may include marks or other features resulting from ordinary manufacturing processes. The unstructured major surface can be characterized in terms a surface roughness and/or in terms of a haze. In some embodiments, the unstructured major surface 281 has an average peak-to-valley surface roughness Rz of less than about 2, 1.5, 1, 0.5, 0.4, 0.3, 0.2, or 0.1 micrometers. In some embodiments, the optical film 150, 150′ has a transmitted haze of less than about 5, 4.5, 4, 3.5, 3, 2.5, 2, 1.5, or 1 percent. Transmitted haze can be determined according to the ASTM D1003-13 test standard, for example.

The protective layer(s) may have a same composition as one of the first and second polymeric layers. Suitable materials for the various layers include, for example, polyethylene naphthalate (PEN), coPEN (copolyethylene naphthalate terephthalate copolymer), polyethylene terephthalate (PET), polyhexylethylene naphthalate copolymer (PHEN), syndiotactic polystyrene (sPS), glycol-modified PET (PETG), glycol-modified PEN (PENG), coPET-polycarbonate alloys, various other copolyesters such as those described elsewhere herein, polyolefins, polymethyl methacrylate (PMMA), coPMMA (a copolymer of methyl methacrylate and ethyl acrylate), other acrylics, or blends thereof. Other suitable materials for the various layers include those described in U.S. Pat. No. 5,103,337 (Schrenk et al.); U.S. Pat. No. 5,540,978 (Schrenk); U.S. Pat. No. 5,882,774 (Jonza et al.); U.S. Pat. No. 6,179,948 (Merrill et al.); U.S. Pat. No. 6,207,260 (Wheatley et al.); U.S. Pat. No. 6,783,349 (Neavin et al.); U.S. Pat. No. 6,967,778 (Wheatley et al.); U.S. Pat. No. 9,069,136 (Weber et al.); and U.S. Pat. No. 9,162,406 (Neavin et al.), for example.

In some embodiments, at least one of the first and second polymeric layers comprises a polymer comprising naphthalate groups (e.g., PEN or coPEN). In some embodiments, at least one of the first and second polymeric layers comprises a polymer comprising terephthalate groups (e.g., PET or coPET). In some embodiments, the first polymeric layers are birefringent, and the second polymeric layers are substantially optically isotropic. The birefringent layers can comprise a polymer comprising naphthalate groups and/or terephthalate groups. The substantially isotropic layers can comprise a polyester, copolyester, or a polycarbonate/copolyester alloy, for example. In addition, or alternatively, the protective layer(s) can be formed from any of these materials. Such materials have been found to bond well to the bonding layers described elsewhere herein that can bond well to an olefin layer.

The birefringent layers can have a maximum birefringence (e.g., absolute value of refractive index difference in x- and z-directions) at a first wavelength (e.g., 532 nm, 550 nm, or 633 nm) in a wavelength range of about 400 nm to about 700 nm of greater than about 0.05, 0.08, 0.1, 0.12, or 0.15, for example. The substantially isotropic layers can have a maximum birefringence at the first wavelength of less than about 0.025, 0.02, 0.015, 0.01, or 0.005, for example. The birefringent layers can have a refractive index along at least one direction greater than a refractive index of the substantially isotropic layers by at least about 0.05, 0.08, 0.1, 0.12, or 0.15, for example, for at least the first wavelength. The maximum difference in refractive indices between different layers along a same direction or between different directions in a same layer may be up to about 0.5, 0.4, or 0.3, for example, at the first wavelength.

In some embodiments, the bonding layer 26 has a glass transition temperature (Tg) less than about −100° C. or less than about −120° C. In some such embodiments, or in other embodiments, the bonding layer has a melting point greater than about 100° C. or greater than about 120° C. For example, the bonding layer 26 can have a glass transition temperature less than about −100° C. and a melting point greater than about 100° C. In some embodiments, the olefin layer 28 has a glass transition temperature in a range of 100° C. to 115° C. or 105° C. to 110° C. Having the Tg of the olefin layer 28 in these range helps with the processability of the film. For example, with some processing methods, too low a Tg and the film can stick to the tentor clips, while too high Tg can result in the film not orienting as desired and developing the desired optics. The glass transition temperature can be determined by differential scanning calorimetry according to the ASTM E1356-08 (Reapproved 2014) standard, for example.

In some embodiments, the bonding layer 26 (and/or other layers of the optical film 150, 150′) has a weight-averaged molecular weight greater than about 20,000, 30,000, 40,000 or 50,000 Daltons or in a range described elsewhere herein. In some embodiments, a composition of the bonding layer 26 is different from compositions of each of the first protective layer 24 and the first and second polymeric layers 21 and 22. The bonding layer 26 can be or include an ethylene copolymer. The ethylene copolymer can include one or more of a styrenic group, an acrylic group, a vinyl group, or a maleic anhydride group, for example. Suitable ethylene copolymers include those available from KRATON Corporation (Huston, TX) under the KRATON tradename and those available from Dow Chemical (Midland, MI) under the BYNEL and ELVALOY tradenames, for example. The bonding layer 26 may be or include a PETG layer, for example. Suitable PETG includes GN071 available from Eastman Chemical (Kingsport, TN), for example.

In some embodiments, the optical film 150, 150′ includes an ethylene copolymer layer 26 disposed on the first protective layer 24 opposite the plurality 20 of alternating first and second polymeric layers 21 and 22. In some embodiments, the optical film 150, 150′ further includes an olefin layer 28, where the ethylene copolymer layer 26 bonds the olefin and first protective layers to one another. The ethylene copolymer layer 26 can include an ethylene copolymer as described further elsewhere herein.

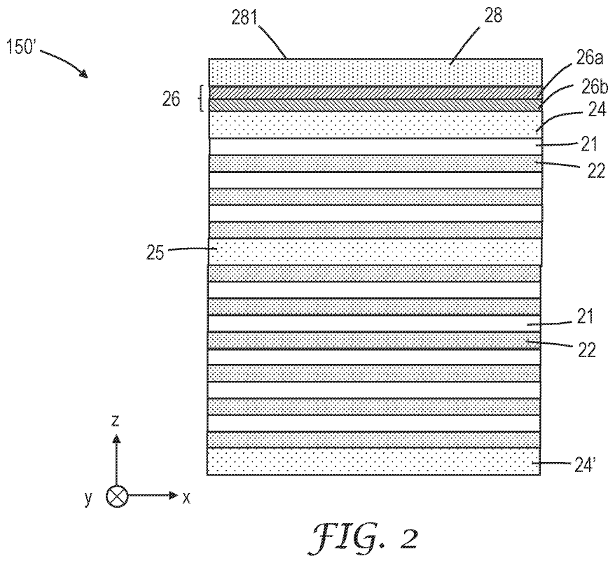

The olefin layer 28 can comprises cyclic olefin copolymer (COC), cyclic olefin polymer (COP), or a blend thereof, for example. Suitable olefin polymers and copolymers for the olefin layer 28, and/or for the lens substrate 220 (see, e.g., FIG. 3), include those available from TOPAS Advanced Polymers GmbH (Raunheim, Germany) under the TOPAS tradename and those available from Zeon Specialty Materials, Inc. (San Jose, CA) under the ZEONOR tradename, for example.

The materials of the various layers can be selected to provide a high delamination force. In some embodiments, the optical film has an average delamination force of greater than about 100, 200, 300, 500, 1000, 1500, 2000, 3000, 4000, 4500, or 5000 g/in. In some embodiments, the delamination force is so high that the layers of a 1 inch wide strip of the film cannot be delaminated using a 10 pound load cell. The delamination force is determined using a 90 degree peel with a pull speed of 12 inches per minute, unless indicated differently. In some embodiments, an optical film having an average delamination force in any of these ranges is formed from a plurality of alternating first and second polymeric layers disposed on a first protective layer with a bonding layer disposed on the first protective layer opposite the plurality of alternating first and second polymeric layers, where each of the first polymeric layers comprises a polymer comprising naphthalate groups and/or terephthalate groups; each of the first protective layer and the second polymeric layers comprises a polyester, copolyester, or polycarbonate/copolyester alloy; and the bonding layer comprises an ethylene copolymer. The polyester, copolyester, or polycarbonate/copolyester alloy of the first protective layer may have the same or different composition as the polyester, copolyester, or polycarbonate/copolyester alloy of the second polymeric layers. The ethylene copolymer can include one or more of a styrenic group, an acrylic group, a vinyl group, or a maleic anhydride group.

In some embodiments, each layer of the optical film 150, 150′ is formed from a thermoplastic polymer. The thermoplastic polymers can be selected to be readily extrudable and processable. For example, the thermoplastic polymers can be selected to have molecular weights and/or intrinsic viscosities and/or melt flow indices (MFIs) in suitable ranges for extrudability. In some embodiments, each of the thermoplastic polymers has a weight-averaged molecular weight Mw greater than 20,000 Daltons, or greater than 30,000 Daltons, or greater than 40,000 Daltons, or greater than 50,000 Daltons. The weight-averaged molecular weight Mw can be up to 1,000,000 Daltons, or up to 600,000 Daltons or up to 400,000 Daltons, or up to 200,000 Daltons or up to 150,000 Daltons, for example. In some such embodiments, or in other embodiments, each of the thermoplastic polymers has an intrinsic viscosity in range of 0.3 dl/g to 1.2 dl/g or 0.4 dl/g to 1.0 dl/g when measured in a solvent blend comprising 60 weight percent o-chlorobenzene and 40 weight percent phenol. In some such embodiments, or in other embodiments, the thermoplastic polymers have a melt flow index greater than 5 g/10 min, or greater than 10 g/10 min, or greater than 20 g/10 min. The melt flow index may be up to 300 g/10 min, or up to 200 g/10 min, or up to 100 g/10 min, for example. The weight averaged molecular weight Mw can be determined using gel permeation chromatography, for example. The intrinsic viscosity can be determined using a capillary viscometer, for example. The melt flow index, which may alternatively be referred to as melt flow rate, can be determined using an extrusion plastometer according to ASTM D1238-20, for example.

The optical film 150, 150′ can be integrally formed. As used herein, a first element “integrally formed” with a second element means that the first and second elements are manufactured together rather than manufactured separately and then subsequently joined.

Integrally formed includes manufacturing a first element followed by manufacturing the second element on the first element. An optical film including a plurality of layers is integrally formed if all of the layers are manufactured together (e.g., combined as melt streams and then cast onto a chill roll to form a cast film having each of the layers, and then orienting the cast film) rather than manufactured separately and then subsequently joined. In some embodiments, all layers of the optical film 150, 150′ are coextruded. In some embodiments, all layers of the optical film 150, 150′ are further co-stretched.

As is known in the art, multilayer optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.), for example.

In some embodiments, the optical film 150, 150′ is a reflective polarizer. In some embodiments, for substantially normally incident (e.g., angle of incidence less than about 30, 20, 10, or 5 degrees) light 140 and for a predetermined wavelength range (e.g., 400 nm to 700 nm, or 425 nm to 675 nm, or 450 nm to 650 nm), the reflective polarizer has an average optical reflectance of at least 60 percent for a first polarization state 141 and an average optical transmittance of at least 60 percent for an orthogonal second polarization state 142. The average optical reflectance for the first polarization state 141 can be at least 70, 80, or 90 percent, for example. The average optical transmittance for the second polarization state 142 can be at least 70, 80, or 85 percent, for example. In some embodiments, the optical film 150, 150′ is a mirror film. In some embodiments, for substantially normally incident light 140 and for a predetermined wavelength range, the mirror film has an average optical reflectance of at least 60, 70, 80, or 90 percent for each of orthogonal first and second polarization states 141 and 142. In some embodiments, the optical film 150, 150′ is a partial reflector having an average optical reflectance in a range of 20 to 80 percent, or 30 to 70 percent, or 40 to 60 percent, for each of orthogonal first and second polarization states 141 and 142, for substantially normally incident light 140, and for a predetermined wavelength range.

FIG. 3 is a schematic cross-sectional view of an optical lens 200, according to some embodiments. The optical lens 200 includes a lens substrate 220 and any optical film 250 (e.g., corresponding to optical film 150 or 150′) of the present description disposed on, and substantially conforming to, a major surface 221 of the lens substrate 220. The olefin layer 28 and/or the ethylene copolymer layer can face the lens substrate 220 (see, e.g., the x-y-z coordinate systems schematically illustrated in FIGS. 1-3). In some embodiments, the lens substrate 220 comprises an olefin composition. The olefin composition can be or include cyclic olefin polymer (COP), cyclic olefin copolymer (COP), or a blend thereof. In some such embodiments, or in other embodiments, the olefin layer 28 bonds the optical film 250 to the lens substrate 220.

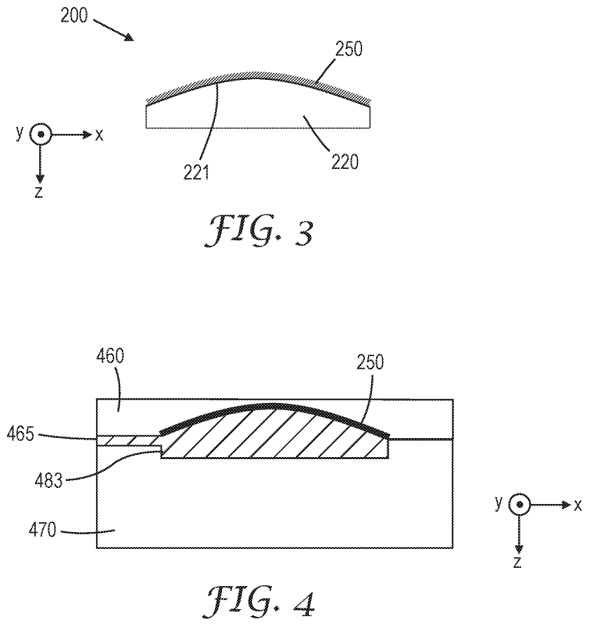

FIG. 4 is a schematic illustration of a method of making an optical lens, according to some embodiments. The method includes providing an integrally formed optical film 250 which can be as described elsewhere herein for optical film 150, 150′. For example, the optical film 250 can include a plurality 20 of alternating first and second polymeric layers 21, 22 disposed on a first protective layer 24; an olefin layer 28 disposed on the first protective 24 layer opposite the plurality of alternating first and second polymeric layers 21, 22; and a bonding layer 26 disposed between, and bonding together, the olefin layer 28 and the first protective layer 24. The method includes molding a lens substrate 220 onto the optical film 250 such that the lens substrate faces 220 and bonds to the olefin layer 28. The lens substrate can comprise an olefin composition. The olefin layer can comprise cyclic olefin copolymer, cyclic olefin polymer, or a blend thereof. Providing the integrally formed optical film can include coextruding and co-stretching all layers of the optical film. Molding the lens substrate 220 onto the optical film 250 can include an insert molding process where, in brief summary, the optical film 250 is placed adjacent a surface of an upper mold portion 460 and resin 483 (e.g., a molten olefin composition) is injected into a cavity (e.g., through gate 465) between the optical film 250 and a bottom mold portion 470. Further details on insert molding processes can be found, for example, in U.S. Pat. Appl. Pub. No. 2021/0208320 (Ambur et al.) and in U.S. Pat. No. 11,065,855 (Klun et al.).

### EXAMPLES

All parts and percentages in the Examples are by weight unless indicated otherwise.

Reagents and solvents are available from MILLIPORE-SIGMA (Burlington, MA), except wherein indicated otherwise.

| Material | Description |
|---|---|
| TOPAS 8007F | Cyclic olefin copolymer (COC) available from Advanced |
| | Polymers GmbH (Raunheim, Germany) |
| TOPAS 8007S | COC available from Advanced Polymers GmbH (Raunheim, |
| | Germany) |
| TOPAS 6013S | COC available from Advanced Polymers GmbH (Raunheim, |
| | Germany) |
| TOPAS E140 | COC elastomer available from Advanced Polymers GmbH |
| | (Raunheim, Germany) |
| ZEONOR 1420r | Cyclic olefin polymer (COP) available from Zeon Specialty |
| | Materials, Inc. (San Jose, CA) |
| KRATON 1645 | Styrene-ethylene-butylene-styrene (SEBS) available from |
| | KRATON Corporation (Huston, TX) |
| ELVALOY 1125AC | Ethylene methyl acrylate (EMA) available from Dow |
| | Chemical (Midland, MI) |
| BYNEL 22E780 | Ethylene copolymer available from Dow Chemical (Midland, |
| | MI) |
| ELVALOY 2618 | Ethylene methyl acrylate (EMA) available from Dow |
| | Chemical (Midland, MI) |
| BYNEL 3101 | Ethylene vinyl acrylate (EVA) available from Dow Chemical |
| | (Midland, MI) |
| LMPEN | Low-melt PEN (coPEN with 90 percent naphthalate groups) |
| PEN | Polyethylene naphthalate (PEN) |
| LMPEN | Low-melt PEN (coPEN with 90 percent naphthalate groups) |
| PET | PET having an intrinsic viscosity of 0.62 |
| GN071 | Glycol-modified PET (PETG) available from Eastman |
| | Chemical (Kingsport, TN) |

Two sets of films having the layer structure ABCBA were made via coextrusion followed by co-stretching for some film samples. The films showed that coextrudable/co-strechable materials can be chosen for B layers when the A layers were formed from an olefin and the C layer was formed from a polyester commonly used in multilayer optical films. Films having the structure ABC′DCDCDC . . . , for example, where C′ is a protective layer (e.g., a protective boundary layer) and the alternating D and C layers are adapted to reflect light primarily by optical inference, for example, can be made similarly.

The first set of films having an ABCBA structure were made via the following procedure. The outer (A) layers were produced by extruding resin through a 27 mm TSE (twin-screw extruder) through a neck tube and gear pump into a 5 layer feed block and die. This melt train used a progressive temperature extrusion profile, with peak temperatures of 270° C. The bonding (B) layer was produced by extruding resin through a 27 mm TSE with a progressive temperature profile peaking at or around 260° C. through a neck tube and gear pump into a 5 layer feed block. The core (C) layer was produced by extruding the above identified resin through a 27 mm TSE with a progressive temperature profile peaking at or around 270° C. through a neck tube and gear pump into a 5 layer feed block. The feedblock/die was held at a target temp of 270° C. while the casting wheel was run between 50° C. and 70° C. The film materials were as indicated in the following table. Feed rates for each of the TSEs was 10 lbs/hr except for the C layer of Sample 10 where a 14.4 lbs/hr feed rate was used. Parts by weight are indicated in parentheses for blends.

| | A Layer | B Layer | C Layer |
|---|---|---|---|
| Film No. | Resin | Resin | Resin |
| 1 | ZEONOR | GN071 | LMPEN |
| | 1420r | | |
| 2 | ZEONOR | GN071 | LMPEN |
| | 1420r/ | | |
| | TOPAS 8007F | | |
| | (70/30) | | |
| 3 | ZEONOR | KRATON | LMPEN |
| | 1420r/ | 1645 | |
| | TOPAS 8007F | | |
| | (70/30) | | |
| 4 | ZEONOR | BYNEL | LMPEN |
| | 1420r/ | 22E780 | |
| | TOPAS 8007F | | |
| | (70/30) | | |
| 5 | ZEONOR | ELVALOY | LMPEN |
| | 1420r/ | 2618 | |
| | TOPAS 8007F | | |
| | (70/30) | | |
| 6 | ZEONOR | BYNEL | LMPEN |
| | 1420r/ | 3101 | |
| | TOPAS 8007F | | |
| | (70/30) | | |
| 7 | ZEONOR | KRATON | LMPEN |
| | 1420r/ | 1645 | |
| | TOPAS 8007F | | |
| | (80/20) | | |
| 8 | TOPAS | KRATON | LMPEN |
| | 8007F | 1645 | |
| 9 | TOPAS | KRATON | LMPEN/ |
| | 8007F | 1645 | PET (7.5/2.5) |
| 10 | TOPAS | KRATON | LMPEN/ |
| | 8007F | 1645 | PET (7.5/2.5) |
| 11 | TOPAS | KRATON | LMPEN/ |
| | 8007F | 1645 | PET (11.25/3.15) |
| 12 | TOPAS | KRATON | PET |
| | 8007F | 1645 | |

Various film samples were oriented and annealed in a two stage KARO IV lab stretching device (available from Bruckner Maschinenbau Siegsdorf, Germany) using the following procedure: Cast web films were conveyed into the oven at various temperatures as indicated in the tables below and held for 60 seconds and then stretched at several different ratios as indicated in the tables below (the oriented area of the film is x by X longer in each direction than the initial film when the draw ratio is given as x by X). The film was then removed from the KARO and evaluated. Transmitted haze was measured using a haze-gard i haze meter available from BYK Instruments.

The transmitted haze (in percent) for film samples stretched at a 1×5 draw ratio are reported in the following table.

| | 1 × 5 | | | | |
|---|---|---|---|---|---|
| Film No. | 130° C. | 135° C. | 140° C. | 145° C. | 150° C. |
| 9 | | 2.91 | | | |
| 10 | 2.68 | 4.04 | 0.55 | 1.01 | 0.83 |
| 11 | 3.17 | 4.27 | | | |

The transmitted haze (in percent) for film samples stretched at a 1×5.5 draw ratio are reported in the following table.

| | 1 × 5.5 | | | | |
|---|---|---|---|---|---|
| | 130° C. | 135° C. | 140° C. | 145° C. | 150° C. |
| 9 | | 2.81 | | | |
| 10 | 2.46 | 2.02 | 0.75 | 1 | 0.87 |
| 11 | 1.96 | 4.76 | | | |

The transmitted haze (in percent) for film samples stretched at a 1×6 draw ratio are reported in the following table.

| | 1 × 6 | | | | |
|---|---|---|---|---|---|
| | 130° C. | 135° C. | 140° C. | 145° C. | 150° C. |
| 9 | | 2.99 | | | |
| 10 | 2.5 | 2.23 | 1.73 | 1.23 | 0.74 |
| 11 | 2.74 | 3.81 | | | |

The transmitted haze (in percent) for film samples stretched at the indicated draw ratios and annealed at 215° C. for 15 seconds are reported in the following table.

| | 1 × 5 | | 1 × 5.5 | | 1 × 6 | |
|---|---|---|---|---|---|---|
| | 130° C. | 135° C. | 130° C. | 135° C. | 130° C. | 135° C. |
| 10 | 0.52 | 0.24 | 0.49 | 0.33 | 0.48 | 0.61 |
| 11 | 0.37 | 0.34 | 0.35 | 0.33 | 0.4 | 0.37 |

The transmitted haze (in percent) for a film sample that had not been annealed and for a corresponding sample that was annealed at 215° C. for 15 seconds are reported in the following table.

1 × 5

| | | 105° C. |
|---|---|---|
| | | Annealed |
| | 105° C. | at 215° C. |
| 12 | 4.35 | 1.05 |

The transmitted haze (in percent) for film samples biaxially stretched at the indicated draw ratios are reported in the following table.

135° C.

| | 3 × 3 | 3.5 × 3.5 |
|---|---|---|
| 10 | 4.28 | 4.79 |
| 11 | 2.7 | 4.17 |

The transmitted haze (in percent) for film samples biaxially stretched at the indicated draw ratios and annealed at 215° C. for 15 seconds are reported in the following table.

135° C.

| | 3 × 3 | 3.5 × 3.5 |
|---|---|---|
| 10 | 1.05 | 0.5 |
| 11 | 0.36 | 0.42 |

The second set of films having an ABCBA structure were made to determine effects the A layer composition (e.g., effect of the glass transition temperature of COC blends) on optical and bonding properties, for example. Film samples were made as generally described above with the resins indicated in the table below. The feed rate for each of the TSEs was 10 lbs/hr for each sample.

| | A Layer | B Layer | C Layer |
|---|---|---|---|
| Description | Resin | Resin | Resin |
| 13 | TOPAS 8007F | GN071 | PEN |
| 14 | TOPAS 8007F | KRATON | PEN |
| | | 1645 | |
| 15 | TOPAS 8007F/ | KRATON | PEN |
| | TOPAS | 1645 | |
| | 6013S (40/60) | | |
| 16 | TOPAS 8007F/ | KRATON | PEN |
| | TOPAS | 1645 | |
| | 6013S (30/70) | | |
| 17 | TOPAS 8007F/ | KRATON | PEN |
| | TOPAS | 1645 | |
| | 6013S (20/80) | | |
| 18 | TOPAS 8007F/ | KRATON | PEN |
| | TOPAS | 1645 | |
| | E140 (95/05) | | |
| 19 | TOPAS 8007F/ | KRATON | PEN |
| | TOPAS | 1645 | |
| | E140 (80/20) | | |
| 20 | TOPAS 8007F/ | KRATON | PEN |
| | TOPAS | 1645 | |
| | E140 (60/40) | | |

The glass transition temperatures (Tg) of the A layers were obtained using a Differential Scanning Calorimeter (DSC). The DSC used a heat/cool/heat cycle. Each sample was weighed and placed in a DSC. The following Method was used. Method Log:
1: Data storage: Off
2: Equilibrate at −70.00° C.
3: Isothermal for 5.00 min
4: Data storage: On
5: Ramp 20.00° C./min to 200.00° C.
6: Mark end of cycle 1
7: Data storage: Off
8: Equilibrate at 200.00° C.
9: Isothermal for 5.00 min
10: Data storage: On
11: Ramp 20.00° C./min to −70.00° C.
12: Mark end of cycle 2
13: Data storage: Off
14: Equilibrate at −70.00° C.
15: Modulate +/−1.00° C. every 60 seconds
16: Isothermal for 5.00 min
17: Data storage: On
18: Ramp 3.00° C./min to 200.00° C.
19: Mark end of cycle 3
20: Data storage: Off
21: End of method

The Tg was then measured at the inflection point of the hump during the second ramp cycle starting at step 18, which one skilled in the art would recognize as the Tg. The resulting Tgs are reported in the following table.

| Film No. | Resin Blend | Tg (° C.) |
|---|---|---|
| 15 | TOPAS 8007F/TOPAS | 112 |
| | 6013S (40/60) | |
| 16 | TOPAS 8007F/TOPAS | 117 |
| | 6013S (30/70) | |
| 17 | TOPAS 8007F/TOPAS | 122 |
| | 6013S (20/80) | |
| NA | TOPAS 8007F | 78 |
| NA | TOPAS 6013S | 138 |

Film samples were uniaxially oriented in the two stage KARO lab stretching device using the following procedure: Cast web films were conveyed into the oven at various temperatures and held for 60 seconds and then stretched at several different ratios. The film was then removed from the KARO and evaluated for haze as described above. The resulting transmitted haze in percent for various draw ratios and oven temperatures are indicated in the tables below.

| | 140° C. | | | 145° C. | | |
|---|---|---|---|---|---|---|
| Film No. | 1 × 5 | 1 × 5.5 | 1 × 6 | 1 × 5 | 1 × 5.5 | 1 × 6 |
| 15 | 2.42 | 2.69 | 2.6 | 1.73 | 1.97 | 3.39 |
| 16 | 1.92 | | 0.41 | 2.57 | 2.64 | 2.42 |
| 17 | 68.7 | | | 2.01 | 2.01 | 1.86 |
| 19 | | | 1.48 | | | |
| 20 | | | 40.1 | | | |

| | 150° C. | | |
|---|---|---|---|
| Film No. | 1 × 5 | 1 × 5.5 | 1 × 6 |
| 16 | 3.28 | 3.14 | 3.36 |
| 17 | 2.71 | 2.36 | 2.26 |

Delamination force was then measured for various cast film samples using an IMASS SP-2100 with a 10 lb load cell. The film was cut into 1″ wide samples and laminated to glass with double sided tape. The glass was loaded into the IMASS holder to measure a 90-degree peel. The pull speed was set to 12″/min, with a 2 second delay, and the force was averaged for 5 seconds. This was repeated 4 times. The average was taken and reported. The table below reports the delamination (peel) force data for these films. Many films showed undelamable peel force, or delamination force high enough separation of the film stack would not occur in end use applications.

| | Peel Force |
|---|---|
| Film No. | (g/in) |
| 1 | 5 |
| 2 | 10 |
| 3 | 1679 |
| 4 | Undelamable |
| 5 | Undelamable |
| 6 | Undelamable |
| 7 | Undelamable |
| 9 | 2301 |
| 10 | 2273 |
| 13 | 291 |
| 14 | Undelamable |
| 15 | Undelamable |
| 16 | Undelamable |
| 17 | Undelamable |
| 18 | Undelamable |
| 19 | Undelamable |
| 20 | Undelamable |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical film comprising:
a plurality of alternating first and second polymeric layers disposed on a first protective layer, each of the first and second polymeric layers having an average thickness less than about 500 nm, the first protective layer having an average thickness greater than about 750 nm;
an olefin layer disposed on the first protective layer opposite the plurality of alternating first and second polymeric layers, the olefin layer comprising cyclic olefin copolymer, cyclic olefin polymer, or a blend thereof, the olefin layer comprising an unstructured major surface opposite the first protective layer; and
a bonding layer disposed between, and bonding together, the olefin layer and the first protective layer,
wherein the optical film is integrally formed and has an average delamination force of greater than about 500 g/in, each layer of the optical film being formed from a thermoplastic polymer having a melt flow index greater than 5 g/10 min and an intrinsic viscosity in range of 0.3 dl/g to 1.2 dl/g when measured in a solvent blend comprising 60 weight percent o-chlorobenzene and 40 weight percent phenol.

17. The optical film of claim 16, wherein the unstructured major surface has an average peak-to-valley surface roughness Rz of less than about 1 micrometer.

18. The optical film of claim 16 having a transmitted haze of less than about 5 percent.

19. The optical film of claim 16, wherein a composition of the bonding layer is different from compositions of each of the first protective layer and the first and second polymeric layers.

20. The optical film of claim 16, wherein the bonding layer comprises an ethylene copolymer.

21. The optical film of claim 16, wherein the bonding layer has a glass transition temperature less than about −100° C. and a melting point greater than about 100° C.

22. The optical film of claim 16, wherein the plurality of alternating first and second polymeric layers number at least 10 in total.

23. The optical film of claim 16, wherein the optical film is a reflective polarizer or a mirror film.

24. An optical lens comprising a lens substrate and the optical film of claim 16 disposed on, and substantially conforming to, a major surface of the lens substrate, the olefin layer facing, and bonded to, the lens substrate.

25. An optical film comprising:
a plurality of alternating first and second polymeric layers disposed on a first protective layer, each of the first and second polymeric layers having an average thickness less than about 500 nm, the first protective layer having an average thickness greater than about 750 nm;
an olefin layer disposed on the first protective layer opposite the plurality of alternating first and second polymeric layers, the olefin layer comprising cyclic olefin copolymer, cyclic olefin polymer, or a blend thereof, and
a bonding layer disposed between, and bonding together, the olefin layer and the first protective layer, a composition of the bonding layer being different from compositions of each of the first protective layer and the first and second polymeric layers,
wherein the optical film is integrally formed and has an average delamination force of greater than about 500 g/in, each layer of the optical film being formed from a thermoplastic polymer having a melt flow index greater than 5 g/10 min and an intrinsic viscosity in range of 0.3 dl/g to 1.2 dl/g when measured in a solvent blend comprising 60 weight percent o-chlorobenzene and 40 weight percent phenol.

26. The optical film of claim 25, wherein the bonding layer is an ethylene copolymer layer.

27. The optical film of claim 26, wherein the ethylene copolymer layer comprises an ethylene copolymer comprising one or more of a styrenic group, an acrylic group, a vinyl group, or a maleic anhydride group.

28. The optical film of claim 25, wherein the bonding layer has a glass transition temperature less than about −100° C. and a melting point greater than about 100° C.

29. An optical lens comprising a lens substrate and the optical film of claim 25 disposed on, and substantially conforming to, a major surface of the lens substrate, the olefin layer facing, and bonded to, the lens substrate.

30. A method of making an optical lens, the method comprising:
providing an integrally formed optical film having an average delamination force of greater than about 500 g/in, each layer of the optical film being formed from a thermoplastic polymer having a melt flow index greater than 5 g/10 min and an intrinsic viscosity in range of 0.3 dl/g to 1.2 dl/g when measured in a solvent blend comprising 60 weight percent o-chlorobenzene and 40 weight percent phenol, the optical film comprising:
a plurality of alternating first and second polymeric layers disposed on a first protective layer, each of the first and second polymeric layers having an average thickness less than about 500 nm, the first protective layer having an average thickness greater than about 750 nm;
an olefin layer disposed on the first protective layer opposite the plurality of alternating first and second polymeric layers, the olefin layer comprising cyclic olefin copolymer, cyclic olefin polymer, or a blend thereof, and
a bonding layer disposed between, and bonding together, the olefin layer and the first protective layer; and
molding a lens substrate onto the optical film such that the lens substrate faces and bonds to the olefin layer, the lens substrate comprising an olefin composition.

31. The method of claim 30, wherein providing the integrally formed optical film comprises coextruding and co-stretching all layers of the optical film.
